(19) United States
(12) Patent Application Publication
(10) Pub. No.: US 2026/0170225 A1
(43) Pub. Date: Jun. 18, 2026

(54) OPTIMIZATION OF MANUFACTURING PATTERNS FOR SEMICONDUCTOR DEVICES

(71) Applicant: GDM Holding LLC, Mountain View, CA (US)

(72) Inventor: Cyrus Behroozi, Menlo Park, CA (US)

(21) Appl. No.: 19/323,545

(22) Filed: Sep. 9, 2025

Related U.S. Application Data
(60) Provisional application No. 63/735,044, filed on Dec. 17, 2024.

(51) Int. Cl. G06F 30/398; G06F 30/327; G06F 30/3312; G06F 30/392; G06F 30/394; G06F 111/04; G06F 111/20; G06F 113/18; G06F 119/18

(52) U.S. Cl. CPC G06F 30/398; G06F 30/327; G06F 30/3312; G06F 30/392; G06F 30/394; G06F 2111/04; G06F 2111/20; G06F 2113/18; G06F 2119/18

(57) ABSTRACT

The technology involves improved exploration of design space for semiconductor design and manufacturing by enabling exploration of portions of design space that previous approaches may exclude unnecessarily because of manufacturing constraints associated with particular semiconductor manufacturing processes or systems. According to one aspect, a method includes receiving a target physical design of a semiconductor device to be fabricated using a particular semiconductor manufacturing process or system, and one or more parameters associated with the particular semiconductor manufacturing process or system. A manufacturing pattern corresponding to the target physical design is determined based on the one or more parameters associated with the particular semiconductor manufacturing process or system. Fabrication of the target physical design by the particular semiconductor manufacturing process or system is modeled based on the manufacturing pattern. A result of modeling the fabrication of the target physical design using the manufacturing pattern is evaluated.

### CROSS REFERENCE TO RELATED APPLICATIONS

The present application claims the benefit of and priority to U.S. Provisional Application No. 63/735,044, filed Dec. 17, 2024, the entire disclosure of which is hereby incorporated herein by reference.

### BACKGROUND

In semiconductor design and manufacturing, a target physical design of a semiconductor device is used for fabrication of that semiconductor device. A target physical design may be described in a vector format, such as Graphic Design System (GDS) or Open Artwork System Interchange Standard (OASIS)-type format. Features associated with a given lithography layer of a target physical design may be described by a set of polygons, each polygon being described by a set of vertices. However, a target physical design may include geometries that are not manufacturable by a particular semiconductor manufacturing process or system due to resolution limitations and other physical constraints of that particular semiconductor manufacturing process or system, for example. Thus, a target physical design must satisfy manufacturing constraints associated with a particular semiconductor manufacturing process or system (e.g., mask rules, satisfy mask rule checks (MRCs), geometric design constraints) to ensure manufacturability of that target physical design using that particular semiconductor manufacturing process or system.

Manufacturing constraints, such as geometric design constraints that are associated with a particular semiconductor manufacturing process or system may unnecessarily eliminate potential physical designs that are actually manufacturable by that particular semiconductor manufacturing process or system. Moreover, one or more eliminated potential physical designs that do not satisfy geometric design constraints may provide improved performance as compared to other potential physical designs that do satisfy those geometric design constraints. For instance, a minimum feature size (e.g., minimum feature width) associated with a particular semiconductor manufacturing process or system may eliminate a portion of design space including a single, specific physical design in which a failure occurs. However, that eliminated portion of design space may include other potential physical designs that have no risk of that failure occurring.

### SUMMARY

The technology provides improved exploration of design space for semiconductor design and manufacturing by enabling exploration of portions of design space that previous approaches may exclude unnecessarily because of manufacturing constraints associated with particular semiconductor manufacturing processes or systems (e.g., mask writers). Approaches disclosed herein provide this improved exploration of design space while still ensuring manufacturability. In exploring design space for physical designs of semiconductor devices, manufacturing patterns (e.g., raster patterns, fracture patterns) may be considered to determine whether a target physical design is manufacturable by a particular semiconductor manufacturing process or system. In doing so, approaches may use polygons of arbitrary shapes and/or sizes, irrespective of one or more manufacturing constraints associated with particular semiconductor manufacturing processes or systems to be used in fabrication of target physical designs, to determine manufacturing patterns associated with target physical designs.

In contrast to other approaches, aspects of the present technology enable design space exploration via direct exploration of manufacturing patterns. Approaches disclosed herein utilize parameters and/or limitations of one or more particular semiconductor manufacturing processes or systems to be used in fabrication of target physical designs for semiconductor devices. Because of this, manufacturing patterns determined according to the disclosed approaches are known to be compatible with those particular semiconductor manufacturing processes or systems to be used in fabrication of target physical designs. As such, more potential manufacturing patterns, if not all manufacturing patterns, for a given target physical design are considered, which provides a technical benefit unavailable in conventional approaches.

For instance, other approaches may unnecessarily exclude all manufacturing patterns associated with a target physical design such that that target physical design is excluded. However, the disclosed approaches would not exclude all manufacturing patterns associated with that target physical design, thereby avoiding exclusion of that target physical design and enabling consideration of potential physical designs that other approaches do not. Thus, the disclosed approaches provide improved exploration of design space as compared to other approaches.

An advantage of the disclosed technology is that one or more (e.g., most) manufacturing constraints, such as MRCs, are, by default, satisfied. By way of example, according to one or more approaches disclosed herein, determination of manufacturing patterns for a target physical design is based on a pitch that satisfies manufacturing constraints associated with a particular semiconductor manufacturing process or system to be used in fabrication of that target physical design. Thus, approaches disclosed herein can determine manufacturing patterns for target physical designs, even if those target physical designs include features that are fine in size.

An advantage of the disclosed technology is that optimization of manufacturing patterns can be performed quicker and/or more efficiently than other approaches. By way of example, the quantity of parameters (e.g., quantity of pixels) associated with a coarse-resolution raster pattern based on a pitch known to be manufacturable by a particular semiconductor manufacturing process or system (e.g., laser mask writer, multi-e-beam mask writer (MBMW)) may be less than (e.g., by a factor of 100 or more) the quantity of parameters (e.g., quantity of pixels) of a high-resolution raster pattern based on polygonal shapes of arbitrary shapes and/or sizes used by previous approaches.

Using native input formats for particular semiconductor manufacturing processes or systems to determine manufacturing patterns ensures manufacturability of a target physical design using those manufacturing patterns and those particular semiconductor manufacturing processes or systems. Thus, potential physical designs that are not manufacturable by those particular semiconductor manufacturing processes or systems are avoided. The technology can converge to improved or optimized physical designs faster and/or have improved scalability than previous approaches.

According to one aspect of the technology, a method includes receiving, by one or more processors, a target physical design of a semiconductor device to be fabricated using a particular semiconductor manufacturing process or system; receiving, by the one or more processors, one or more parameters associated with the particular semiconductor manufacturing process or system; determining, by the one or more processors based on the one or more parameters associated with the particular semiconductor manufacturing process or system, a manufacturing pattern corresponding to the target physical design; modeling, by the one or more processors based on the manufacturing pattern, fabrication of the target physical design by the particular semiconductor manufacturing process or system; and evaluating, by the one or more processors, a result of modeling the fabrication of the target physical design using the manufacturing pattern.

In an example, receiving the one or more parameters may include receiving a native input format associated with the particular semiconductor manufacturing process or system.

Alternatively or additionally to the above, the method may include adjusting, by the one or more processors based on a result of evaluating the manufacturing pattern, one or more parameters of the manufacturing pattern to yield a different manufacturing pattern. Here, adjusting the one or more parameters of the manufacturing pattern may include at least one of turning on one or more primitives of the manufacturing pattern, turning off one or more primitives of the manufacturing pattern, or adjusting a dose associated with one or more primitives of the manufacturing pattern to yield the different manufacturing pattern. Adjusting the one or more parameters of the manufacturing pattern may include at least one of adjusting a height, a width, or shape of one or more primitives of the manufacturing pattern to yield the different manufacturing pattern. The method may further include: modeling, by the one or more processors based on the different manufacturing pattern, fabrication of the target physical design by the particular semiconductor manufacturing process or system; and evaluating, by the one or more processors based on a result of modeling the fabrication of the target physical design based on the different manufacturing pattern, the different manufacturing pattern.

Alternatively or additionally to the above, evaluating the result of modeling the fabrication of the target physical design using the manufacturing pattern may include determining correspondence of the result of modeling the fabrication of the target physical design using the manufacturing pattern to the target physical design.

Alternatively or additionally to the above, evaluating the result of modeling the fabrication of the target physical design using the manufacturing pattern may include determining one or more electrical characteristics or electrical performance metrics of the result of modeling the fabrication of the target physical design.

Alternatively or additionally to the above, the method may include, responsive to a result of evaluating the manufacturing pattern not satisfying a performance metric, adjusting, by the one or more processors, one or more parameters of the manufacturing pattern to yield a different manufacturing pattern. Here, the method may further include: modeling, by the one or more processors based on the different manufacturing pattern, fabrication of the target physical design by the particular semiconductor manufacturing process or system; and determining, by the one or more processors based on a result of modeling the fabrication of the target physical design based on the different manufacturing pattern, whether the different manufacturing pattern satisfies the performance metric.

According to another aspect of the technology, a system is provided that comprises memory configured to: store a target physical design of a semiconductor device to be fabricated using a particular semiconductor manufacturing process or system; and store one or more parameters associated with the particular semiconductor manufacturing process or system; and one or more processors operatively coupled to the memory. The one or more processors are configured to: determine, based on the one or more parameters associated with the particular semiconductor manufacturing process or system, a manufacturing pattern corresponding to the target physical design; model, based on the manufacturing pattern, fabrication of the target physical design by the particular semiconductor manufacturing process or system; and evaluate a result of the modeled fabrication of the target physical design using the manufacturing pattern.

In an example, the one or more parameters may include a native input format associated with the particular semiconductor manufacturing process or system.

Alternatively or additionally to the above, the one or more processors may be further configured to adjust, based on a result of the evaluation of the manufacturing pattern, one or more parameters of the manufacturing pattern to yield a different manufacturing pattern. Here, the one or more processors may be further configured to turn on one or more primitives of the manufacturing pattern, turn off one or more primitives of the manufacturing pattern, or adjust a dose associated with one or more primitives of the manufacturing pattern to yield the different manufacturing pattern. The one or more processors may be further configured to adjust a height, a width, or shape of one or more primitives of the manufacturing pattern to yield the different manufacturing pattern. The one or more processors may be further configured to: model, based on the different manufacturing pattern, fabrication of the target physical design by the particular semiconductor manufacturing process or system; and evaluate, based on a result of the modeled fabrication of the target physical design based on the different manufacturing pattern, the different manufacturing pattern.

Alternatively or additionally to the above, the one or more processors may be further configured to determine correspondence of the result of the modeled fabrication of the target physical design using the manufacturing pattern to the target physical design.

Alternatively or additionally to the above, the one or more processors may be further configured to determine one or more electrical characteristics or electrical performance metrics of the result of the modeled fabrication of the target physical design.

Alternatively or additionally to the above, the one or more processors may be further configured to, responsive to a result of the evaluation of the manufacturing pattern not satisfying a performance metric, adjust one or more parameters of the manufacturing pattern to yield a different manufacturing pattern. Here, the one or more processors are further configured to: model, based on the different manufacturing pattern, fabrication of the target physical design by the particular semiconductor manufacturing process or system; and determine, based on a result of the modeled fabrication of the target physical design based on the different manufacturing pattern, whether the different manufacturing pattern satisfies the performance metric.

### BRIEF DESCRIPTION OF THE DRAWINGS

FIG. 1 illustrates an integrated circuit design flow in accordance with aspects of the technology.

FIG. 2 illustrates an example system that may be employed with aspects of the technology.

FIGS. 3A-C illustrate examples of raster patterns and VSB fracture patterns that may be employed with aspects of the technology.

FIG. 4 illustrates an example method in accordance with aspects of the technology.

### DETAILED DESCRIPTION

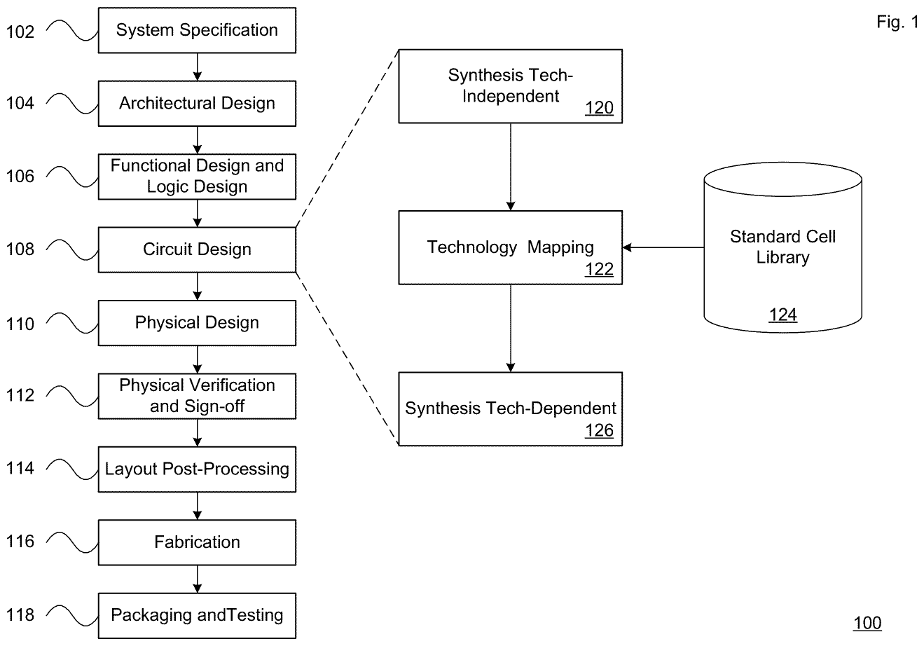

FIG. 1 illustrates an exemplary integrated circuit design flow 100 for use with aspects of the technology, including generating a circuit design and/or fabricating an integrated circuit that incorporates optimization of spline-based representations of interconnects. As shown, the design flow may include preparing a system specification at block 102, such as to identify system-level requirements for the integrated circuit. The system specification is intended to capture the overall goal of the desired integrated circuit. This may include determining the device's cost, performance, general architecture, how off-chip communication will be conducted, etc. The process flow may also include performing architectural design at block 104. At this stage, the design's architecture and its layout are determined by design engineers. This can include integration of memory management, analog and/or mixed-signal components, on-device and external communication, any power constraints, choice of process technology and/or layer stacks, etc.

The process flow continues with performing functional design and logic design at block 106, and performing circuit design at block 108. Functional design may include refinement of the design's specification to achieve the functional behavior of the desired system. Logic design involves adding the design's structure to a behavioral representation of the desired design. Here, considerations include logic minimization, performance enhancement, as well as testability. This stage may consider problems associated with test vector generation, error detection and correction, and the like. By way of example, the functional design and logic design may include generating a behavioral model description (e.g., using HDL) and floor-planning. During circuit design, logic blocks are replaced by corresponding electronic circuits, which may include devices such as resistors, capacitors, and/or transistors. At this stage, circuit simulation may be performed in order to verify timing behavior and other constraints of the system. A Spice tool or other program may be used for circuit simulation.

Once the circuit design is complete, physical design may be performed at block 110 (e.g., component and wiring placement and routing), followed by physical verification and sign-off at block 112 (e.g., to obtain GDSII information with shapes to form the masks used to create the layers for fabricating the integrated circuit). During physical design, the actual layout of the integrated circuit is performed. Here, all of the components are placed and interconnected using metal interconnections. During this stage, the system may perform optimization of curvilinear interconnects, alternatively or additionally to any other layout operations. A circuit design that is able to pass testing of a circuit simulator in the circuit design stage may be found to be faulty after it has been packaged, e.g., due to geometric design rule issues. Thus, physical design rules are followed to ensure correctness during chip fabrication. Errors may include short or open circuits, open channels, or other issues may result when physical design rules are not followed. During physical verification and sign-off, the system performs any verification steps that are required before chip manufacturing. This can include design rule checking and correction, timing simulation, electromagnetic simulation, etc.

Layout post-processing occurs at block 114, then fabrication at block 116, and the packaging and testing at block 118. At block 114, the layout post-processing may include geometry processing before actual manufacturing, e.g., any dummy fill insertion, correction for optical proximity, mask optimization, etc. Fabrication comprises semiconductor manufacturing, which includes stages such as lithography patterning (masking), baking or annealing, etching, etc. Then the raw die of the chip is inserted into a package and I/O pins are connected to the package at block 118. Testing of the chip also occurs at this stage.

As shown, in the circuit design phase of block 108, the process may involve technology-independent synthesis at block 120. This step involves transferring the circuit definitions, such as register-transfer-level (RTL) descriptions, into generic data structures such as And-inverter graph (AIG), and optimizing the circuit in terms of nodes and levels. At block 122, technology mapping is performed based on information from a standard cell library 124. This step involves maps the generic optimized AIG descriptions into real, manufacturable standard cells included in the standard cell library. From this, technology-dependent synthesis is then performed at block 126. This step further optimizes the circuit defined in the gate-level netlist in terms of power, performance and area, using standard-cell-based definitions from block 122.

### Example Integrated Circuit Development System

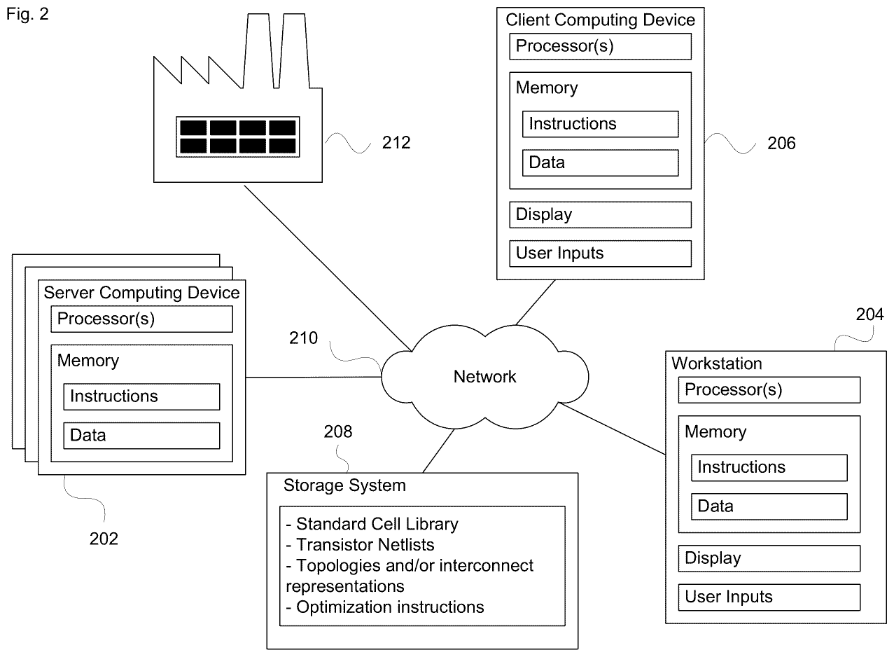

One example of a system for performing circuit design is shown in FIG. 2. In particular, FIG. 2 is a functional diagram, of an example system 200 that includes a plurality of computing devices 202, 204, 206 and a storage system 208 connected via a network 210. System 200 may also include a fabrication facility 212 that is configured to produce integrated circuits designed according to the processes described herein. As shown in FIG. 2, each of computing devices 202, 204 and 206 may include one or more processors, memory, data and instructions.

By way of example, the one or more processors may be any conventional processors, such as commercially available central processing units (CPUs), graphical processing units (GPUs) or tensor processing unites (TPUs). Alternatively, the one or more processors may include a dedicated device such as an ASIC or other hardware-based processor. As shown in FIG. 2, the memory for each computing device stores information accessible by the one or more processors, including instructions and data that may be executed or otherwise used by the processor(s). The memory may be of any type capable of storing information accessible by the processor, including a computing device or computer-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

Moreover, reference to “one or more processors” herein includes situations where a set of processors may be configured to perform one or more operations. Any combination of such a set of processors may perform individual operations or a group of operations. This may include two or more CPUs, GPUs or TPUs (or other hardware-based processors) or any combination thereof. It may also include situations where the processors have multiple processing cores. Therefore, reference to “one or more processors” does not require that all processors (or cores) in the set must each perform all of the operations. Rather, unless expressly stated, any one of the one or more processors (or cores) may perform different operations when a set of operations is indicated, and different processors (or cores) may perform specific operations, either sequentially or in parallel.

The instructions may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. The instructions may include a method for a optimization of physical designs of semiconductor devices as discussed herein.

The data may be retrieved, stored or modified by processor in accordance with the instructions. For instance, although the claimed subject matter is not limited by any particular data structure, the data may be stored in computing device registers, in a relational database as a table having a plurality of different fields and records, XML documents or flat files, HDL information, GDSII information, etc. The data may also be formatted in any computing device-readable format.

The computing devices may include all of the components normally used in connection with a computing device such as the processor and memory described above as well as a user interface having one or more user inputs (e.g., one or more of a button, mouse, keyboard, touch screen, gesture input and/or microphone), various electronic displays (e.g., a monitor having a screen or any other electrical device that is operable to display information), and speakers. The computing devices may also include a communication system having one or more wired or wireless connections to facilitate communication with other computing devices of system 200 and/or the fabrication facility 212.

The various computing devices may communicate directly or indirectly via one or more networks, such as network 210. The network 210 and any intervening nodes may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, computing device 202 may include one or more server computing devices having a plurality of computing devices, e.g., a load balanced server farm or cloud computing architecture, which exchange information with different nodes of a network for the purpose of receiving, processing, and transmitting the data to and from other computing devices. For instance, computing device 202 may include one or more server computing devices that are capable of communicating with computing devices 204, 206 and the fabrication facility 212 via the network 210. In some examples, client computing device 204 may be an engineering workstation used by a developer to perform circuit design and/or other processes for integrated circuit design and fabrication. Client computing device 206 may also be used by a developer, for instance to prepare system requirements for the integrated circuit or manage the manufacturing process with the fabrication facility 212.

Storage system 208 can be of any type of computerized storage capable of storing information accessible by the server computing devices 202, 204 and/or 206, such as a hard-drive, memory card, ROM, RAM, DVD, CD-ROM, flash drive and/or tape drive. In addition, storage system 208 may include a distributed storage system where data is stored on a plurality of different storage devices which may be physically located at the same or different geographic locations. Storage system 208 may be connected to the computing devices via the network 210 as shown in FIG. 2, and/or may be directly connected to or incorporated into any of the computing devices.

Storage system 208 may store various types of information. For instance, the storage system 208 may store parameters and native input formats associated with semiconductor fabrication processes or systems as well as instructions for performing optimizations and other processes described herein.

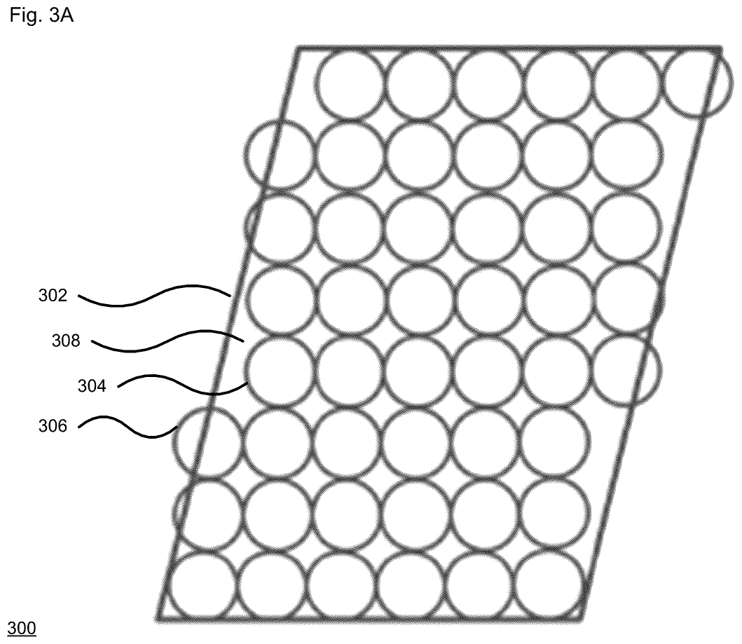

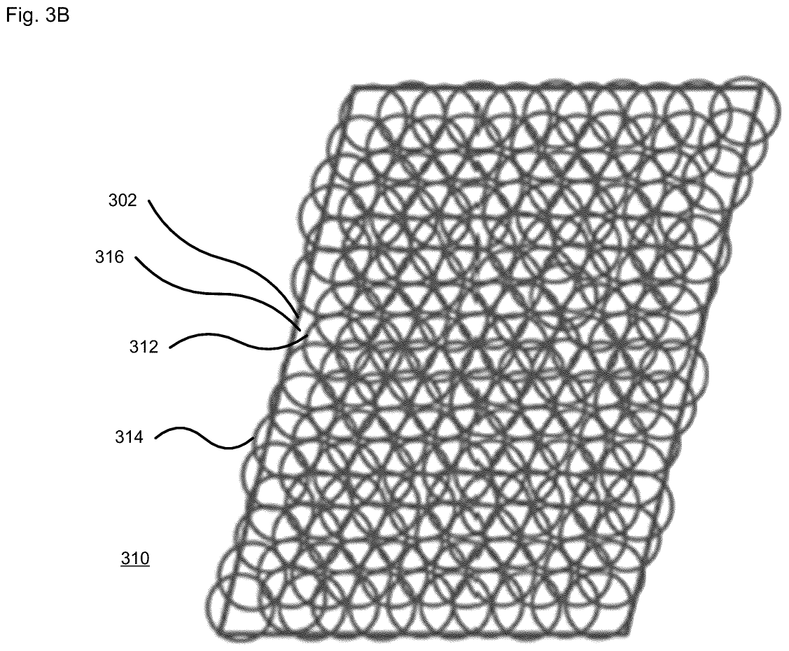

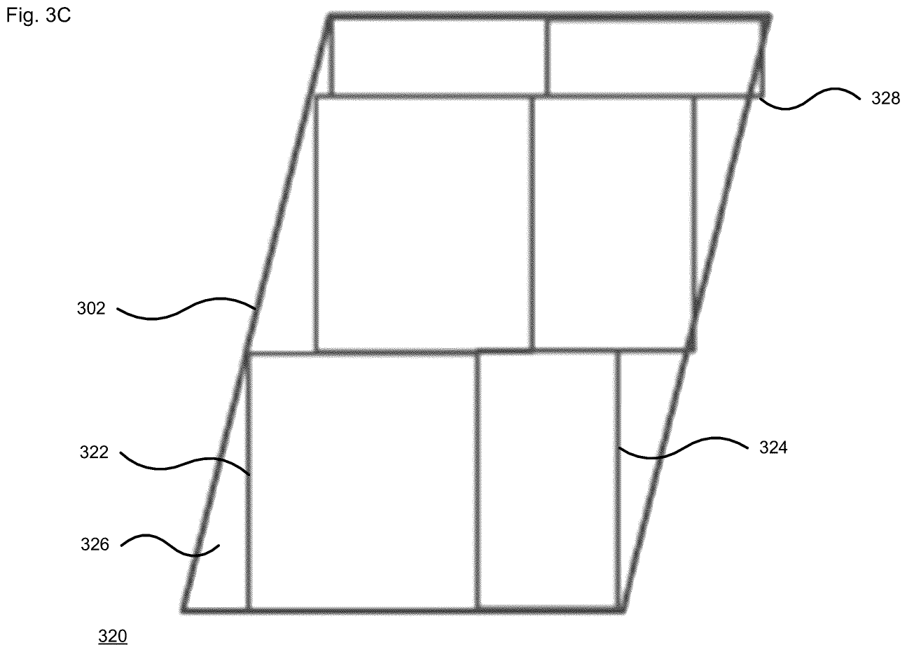

FIGS. 3A-C illustrate examples of raster patterns and a variable shaped beam (VSB) fracture pattern that may be employed with aspects of the technology. FIGS. 3A-C illustrate a polygon 302 representing a feature of a target physical design. Although the polygon 302 is illustrated as a trapezoid, the disclosed technology is not so limited as other geometrical configurations are possible. FIG. 3A illustrates a single beam raster pattern 300 for the polygon 302 associated with a semiconductor physical design. FIG. 3B illustrates an overlap and dose raster pattern 310 for the polygon 302. FIG. 3C illustrates a VSB fracture pattern 320 for the polygon 302. The single beam raster pattern 300 and the overlap and dose raster pattern 310 can be used by a laser mask writer or a MBMW, for instance. The VSB fracture pattern 320 can be used by VSB mask writer, for instance.

Lithography processes may be performed using a mask writer (e.g., laser mask writer, MBMW, VSB mask writer). A mask writer may use one or more particular raster formats and/or fracture patterns. A mask writer may decompose features of a target physical design into one or more polygons (e.g., the polygon 302). The mask writer may decompose those polygons into primitives (e.g., raster point or pixel) according to a raster format or fracture format associated with that mask writer. A size and/or pitch of a primitive are based on, and limited by, parameters and/or limitations of a particular mask writer.

By way of example, the single beam raster pattern 300 decomposes the polygon 302 into forty-eight primitives (e.g., raster points or pixels), such as the primitive 304. In the single beam raster pattern 300, none of the primitives overlap one another. As a result, there are gaps between primitives (e.g., gap 308) in the single beam raster pattern 300. The single beam raster pattern 300 extends beyond the boundary of the polygon 302 (e.g., primitive 306).

By way of example, the overlap and dose raster pattern 310 decomposes the polygon 302 into many more primitives (e.g., raster points or pixels), such as primitive 312, than the single beam raster pattern 300. In the overlap and dose raster pattern 310, some primitives overlap one another, thereby reducing the quantity and size of gaps between primitives (e.g., gap 316) relative to the single beam raster pattern 300. The overlap and dose raster pattern 310 extends beyond the boundary of the polygon 302 (e.g., primitive 314). However, the overlap and dose raster pattern 310 does not extend beyond the boundary of the polygon 302 as much as the single beam raster pattern 300.

By way of example, the VSB fracture pattern 320 decomposes (“fractures”) the polygon 302 into six primitives (e.g., rectangles), such as primitives 322 and 324. Although the VSB fracture pattern 320 includes rectangular primitives, the disclosed technology is not so limited. For example, the VSB fracture pattern 320 may include triangular or trapezoidal primitives in addition or alternative to rectangles. The rectangular primitives of the VSB fracture pattern 320 have fewer gaps (e.g., gap 326) between primitives than the single beam raster pattern 300. However, the gaps between primitives in the VSB fracture pattern 320 are larger than the gaps between primitives in the overlap and dose raster pattern 310. The VSB fracture pattern 320 extends beyond the boundary of the polygon 302 (e.g., primitive 328). However, the VSB fracture pattern 320 does not extend beyond the polygon 302 as much as the single beam raster pattern 300 or the overlap and dose raster pattern 310.

The disclosed technology provides direct exploration of manufacturing patterns. For single-beam raster patterns, such as the single beam raster pattern 300 illustrated by FIG. 3A, for example, one or more primitives (e.g., raster points or pixels) of that single-beam raster pattern can be turned on or turned off to generate another raster pattern. A native input format for a single-beam mask writer can include values indicative of whether each respective primitive is turned on or turned off. This adjustment causes an electron beam of a mask writer corresponding to those primitives to be activated or deactivated. The different raster pattern can be evaluated by evaluating performance of circuitry formed using the different raster pattern as described in further detail below.

For multi-beam raster patterns, such as the overlap and dose raster pattern 310 illustrated by FIG. 3B, for example, respective doses for one or more primitives (e.g., raster points or pixels) can be adjusted to generate another raster pattern. A native input format for a MBMW can include values indicative of respective doses for primitives. By way of example, a dose associated with an electron beam corresponding to a given primitive of the overlap and dose raster pattern 310 can be adjusted to generate a different overlap and dose raster pattern. The different overlap and dose raster pattern can be evaluated by evaluating performance of circuitry formed using the different overlap and dose raster pattern as described in further detail below.

For fracture patterns, such as the VSB fracture pattern 320 illustrated by FIG. 3C, for example, the quantity of primitives and/or sizes and/or shapes of one or more primitives can be adjusted to generate a different fracture pattern. A native input format for a VSB mask writer can include values indicative of respective sizes, locations and/or shapes for primitives. By way of example, sizes (e.g., heights, widths) of one or more primitives of a fracture pattern can be adjusted to generate a different fracture pattern. The different fracture pattern can be evaluated by evaluating performance of circuitry formed using the different fracture pattern as described in further detail below.

The disclosed approaches can include modeling semiconductor processes performed by particular semiconductor manufacturing processes or systems (e.g., mask writing) to determine values for native input formats of those particular semiconductor manufacturing processes or systems. Using a native input format associated with a particular semiconductor manufacturing process or system to determine manufacturing patterns ensures that a target physical design is manufacturable by that particular semiconductor manufacturing process or system. Thus, unlike other approaches, the design space for a particular semiconductor manufacturing process or system can be explored without having to assess legality of raster patterns and fracture patterns within that design space, which can increase the speed with which an optimization is performed and/or an optimization converges to an optimum physical design.

By way of example, a minimum feature size that a particular semiconductor manufacturing process or system is able to fabricate may correspond to a minimum raster pitch of that particular semiconductor manufacturing process or system. Previous approaches may use a manufacturing pattern having an arbitrary pitch and then determine whether that manufacturing pattern having an arbitrary pitch is compatible with a particular semiconductor manufacturing process or system. That is, if a pitch of a manufacturing pattern is smaller than a minimum raster pitch of a particular semiconductor manufacturing process or system, then that manufacturing pattern is incompatible with that particular semiconductor manufacturing process or system.

In contrast, approaches disclosed herein uses a manufacturing pattern having a minimum raster pitch of a particular semiconductor manufacturing process or system, rather than an arbitrary pitch, and models fabrication of circuitry by that semiconductor manufacturing process or system using that manufacturing pattern. Thus, compatibility of a manufacturing pattern with that semiconductor manufacturing process or system is known and does not have to be verified.

Evaluation of a given raster pattern or a given fracture pattern can include modeling of one or more semiconductor manufacturing processes using that raster pattern or fracture pattern. Non-limiting examples of such modeled semiconductor manufacturing processes using a given raster pattern or a given fracture pattern include exposure of a photoresist or electron beam resist, resist development, optics, etching, charging, scattering, and other lithography or lithography-related manufacturing processes. A raster pattern determined by any of the disclosed approaches can be propagated through one or more models of semiconductor manufacturing processes to predict a pattern formed on a wafer (also referred to herein as wafer pattern).

By way of example, modeling one or more semiconductor manufacturing processes using a raster pattern or fracture pattern can be based on physical theory of operation of a particular mask writer as described by the manufacturer of that mask writer. Each beamlet of a mask writer can have a spatial intensity profile that is approximated by a two-dimension Gaussian. Modeling one or more semiconductor manufacturing processes using a mask writer can include summing intensity contributions of all beamlets (e.g., through convolution) to generate an intensity pattern. A mask pattern can be generated by thresholding this intensity pattern.

Alternatively or additionally, rather than using parameters supplied by a manufacturer of a mask writer, parameters can be calibrated by fitting to data and determining parameters for a Gaussian, a combination of Gaussians, a combination of other basis functions, and/or an arbitrary point spread function. The data can include pairs of examples consisting of a design (e.g., beamlet values) and images of fabricated masks. Additionally or alternatively, modeling one or more semiconductor manufacturing processes using a raster pattern or fracture pattern can use a machine leaning (ML) model, such as a convolutional neural network (CNN), to fit to data to determine parameters. Such a ML model can be trained on pairs of examples consisting of a design (e.g., beamlet values) and images of fabricated masks.

After a model of one or more semiconductor manufacturing processes of a mask writer is developed and calibrated, that model can replicate inputs and outputs of that actual mask writer. Inputs to that model can include a mask design described by a raster pattern or fracture pattern, each pixel of that raster pattern or fracture pattern representing an intensity of a corresponding beamlet. Outputs of that model can include contours describing a wafer pattern.

After modeling one or more semiconductor manufacturing processes or systems based on a given manufacturing pattern, that manufacturing pattern can be evaluated. Evaluation of a given manufacturing pattern can include determining correspondence of a wafer pattern formed by a modeled semiconductor manufacturing processes or systems using that manufacturing pattern to a target physical design. By way of example, whether a wafer pattern formed using the overlap and dose raster pattern 310 corresponds to the polygon 302 within a threshold (e.g., margin of error) can be determined. For instance, the wafer pattern can be compared to the polygon 302 by computing a pixel-wise difference between the wafer pattern and the polygon 302. Another way to compare the wafer pattern to the polygon 302 is to represent the wafer pattern as a set of polygons, and compute an edge placement error, which is the distance between the edges of the polygon 302 and the corresponding edges in the wafer pattern. If a pattern formed on a wafer using a given manufacturing pattern does not correspond to a target physical design within a threshold, then a different manufacturing pattern can be determined by any of the disclosed approaches. That different manufacturing pattern can be evaluated as disclosed herein.

Alternatively or additionally, evaluation of a given manufacturing pattern can include evaluating circuitry, or components thereof, formed on a wafer by these semiconductor manufacturing processes. By way of example, electrical characteristics and/or electrical performance metrics of the circuitry can be evaluated using one or more simulations (e.g., electromagnetic simulations). Non-limiting examples of such electrical characteristics and/or electrical performance metrics include resistance, self-capacitance, resource consumption (e.g., power), area, efficiency, and timing. If one or more electrical characteristics and/or electrical performance metrics are not satisfied, then a different manufacturing pattern can be determined by any of the disclosed approaches. That different manufacturing pattern can be evaluated as disclosed herein.

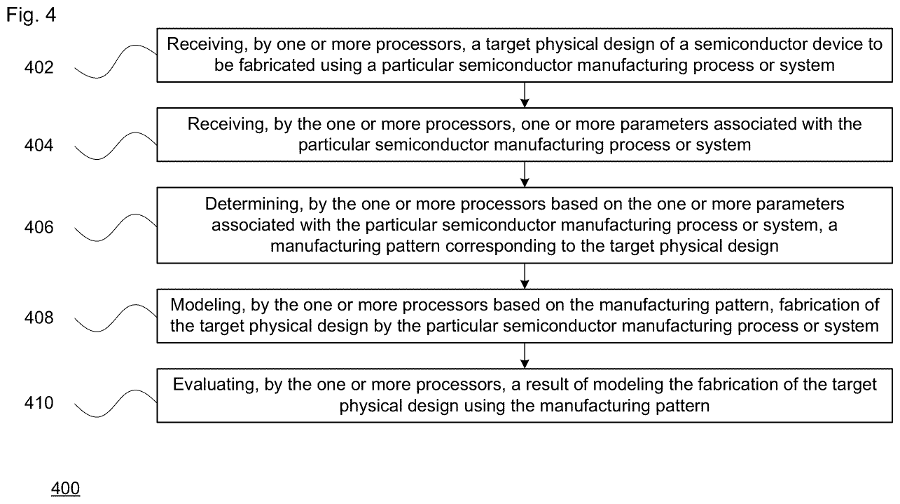

FIG. 4 illustrates an example method 400 in accordance with the above discussion. The method 400 includes, at block 402, receiving, by one or more processors, a target physical design of a semiconductor device to be fabricated using a particular semiconductor manufacturing process or system. At block 404, the method 400 includes receiving, by the one or more processors, one or more parameters associated with the particular semiconductor manufacturing process or system. At block 406, the method 400 includes determining, by the one or more processors based on the one or more parameters associated with the particular semiconductor manufacturing process or system, a manufacturing pattern corresponding to the target physical design. At block 408, the method 400 includes modeling, by the one or more processors based on the manufacturing pattern, fabrication of the target physical design by the particular semiconductor manufacturing process or system. At block 410, the method 400 includes evaluating, by the one or more processors, a result of modeling the fabrication of the target physical design using the manufacturing pattern.

Although the technology herein has been described with reference to particular embodiments and configurations, it is to be understood that these embodiments and configurations are merely illustrative of the principles and applications of the present technology. It is therefore to be understood that numerous modifications may be made to the illustrative embodiments and configurations, and that other arrangements may be devised without departing from the spirit and scope of the present technology as defined by the appended claims.

1. A method comprising:
receiving, by one or more processors, a target physical design of a semiconductor device to be fabricated using a particular semiconductor manufacturing process or system;
receiving, by the one or more processors, one or more parameters associated with the particular semiconductor manufacturing process or system;
determining, by the one or more processors based on the one or more parameters associated with the particular semiconductor manufacturing process or system, a manufacturing pattern corresponding to the target physical design;
modeling, by the one or more processors based on the manufacturing pattern, fabrication of the target physical design by the particular semiconductor manufacturing process or system; and
evaluating, by the one or more processors, a result of modeling the fabrication of the target physical design using the manufacturing pattern.

2. The method of claim 1, wherein receiving the one or more parameters includes receiving a native input format associated with the particular semiconductor manufacturing process or system.

3. The method of claim 1, further comprising adjusting, by the one or more processors based on a result of evaluating the manufacturing pattern, one or more parameters of the manufacturing pattern to yield a different manufacturing pattern.

4. The method of claim 3, wherein adjusting the one or more parameters of the manufacturing pattern includes at least one of turning on one or more primitives of the manufacturing pattern, turning off one or more primitives of the manufacturing pattern, or adjusting a dose associated with one or more primitives of the manufacturing pattern to yield the different manufacturing pattern.

5. The method of claim 3, wherein adjusting the one or more parameters of the manufacturing pattern includes at least one of adjusting a height, a width, or shape of one or more primitives of the manufacturing pattern to yield the different manufacturing pattern.

6. The method of claim 3, further comprising:
modeling, by the one or more processors based on the different manufacturing pattern, fabrication of the target physical design by the particular semiconductor manufacturing process or system; and
evaluating, by the one or more processors based on a result of modeling the fabrication of the target physical design based on the different manufacturing pattern, the different manufacturing pattern.

7. The method of claim 1, wherein evaluating the result of modeling the fabrication of the target physical design using the manufacturing pattern includes determining correspondence of the result of modeling the fabrication of the target physical design using the manufacturing pattern to the target physical design.

8. The method of claim 1, wherein evaluating the result of modeling the fabrication of the target physical design using the manufacturing pattern includes determining one or more electrical characteristics or electrical performance metrics of the result of modeling the fabrication of the target physical design.

9. The method of claim 1, further comprising, responsive to a result of evaluating the manufacturing pattern not satisfying a performance metric, adjusting, by the one or more processors, one or more parameters of the manufacturing pattern to yield a different manufacturing pattern.

10. The method of claim 9, further comprising:
modeling, by the one or more processors based on the different manufacturing pattern, fabrication of the target physical design by the particular semiconductor manufacturing process or system; and
determining, by the one or more processors based on a result of modeling the fabrication of the target physical design based on the different manufacturing pattern, whether the different manufacturing pattern satisfies the performance metric.

11. A system comprising:
memory configured to:
store a target physical design of a semiconductor device to be fabricated using a particular semiconductor manufacturing process or system; and
store one or more parameters associated with the particular semiconductor manufacturing process or system; and
one or more processors operatively coupled to the memory, the one or more processors being configured to:
determine, based on the one or more parameters associated with the particular semiconductor manufacturing process or system, a manufacturing pattern corresponding to the target physical design;
model, based on the manufacturing pattern, fabrication of the target physical design by the particular semiconductor manufacturing process or system; and
evaluate a result of the modeled fabrication of the target physical design using the manufacturing pattern.

12. The system of claim 11, wherein the one or more parameters includes a native input format associated with the particular semiconductor manufacturing process or system.

13. The system of claim 11, wherein the one or more processors are further configured to adjust, based on a result of the evaluation of the manufacturing pattern, one or more parameters of the manufacturing pattern to yield a different manufacturing pattern.

14. The system of claim 13, wherein the one or more processors are further configured to turn on one or more primitives of the manufacturing pattern, turn off one or more primitives of the manufacturing pattern, or adjust a dose associated with one or more primitives of the manufacturing pattern to yield the different manufacturing pattern.

15. The system of claim 13, wherein the one or more processors are further configured to adjust a height, a width, or shape of one or more primitives of the manufacturing pattern to yield the different manufacturing pattern.

16. The system of claim 13, wherein the one or more processors are further configured to:
model, based on the different manufacturing pattern, fabrication of the target physical design by the particular semiconductor manufacturing process or system; and
evaluate, based on a result of the modeled fabrication of the target physical design based on the different manufacturing pattern, the different manufacturing pattern.

17. The system of claim 11, wherein the one or more processors are further configured to determine correspondence of the result of the modeled fabrication of the target physical design using the manufacturing pattern to the target physical design.

18. The system of claim 11, wherein the one or more processors are further configured to determine one or more electrical characteristics or electrical performance metrics of the result of the modeled fabrication of the target physical design.

19. The system of claim 11, wherein the one or more processors are further configured to, responsive to a result of the evaluation of the manufacturing pattern not satisfying a performance metric, adjust one or more parameters of the manufacturing pattern to yield a different manufacturing pattern.

20. The system of claim 19, wherein the one or more processors are further configured to:
model, based on the different manufacturing pattern, fabrication of the target physical design by the particular semiconductor manufacturing process or system; and
determine, based on a result of the modeled fabrication of the target physical design based on the different manufacturing pattern, whether the different manufacturing pattern satisfies the performance metric.
